(19) United States
(12) Patent Application Publication
(10) Pub. No.: US 2014/0358886 A1
(43) Pub. Date: Dec. 4, 2014

(54) INTERNAL SEARCH ENGINES ARCHITECTURE

(71) Applicant: MARVELL WORLD TRADE LTD., St. Michael (BB)

(72) Inventors: Par WESTLUND, Stockholm (SE); Lars-Olof SVENSSON, Stockholm (SE)

(21) Appl. No.: 14/295,727

(22) Filed: Jun. 4, 2014

Related U.S. Application Data
(60) Provisional application No. 61/830,786, filed on Jun. 4, 2013.
(60) Provisional application No. 61/917,215, filed on Dec. 17, 2013.

(51) Int. Cl. G06F 17/30

(52) U.S. Cl. CPC G06F 17/30867
USPC 707/708

(57) ABSTRACT

A pipeline of memory banks is configured to store and retrieve a forwarding address by distributing portions of the address across the memory banks and subsequently searching for the distributed values. A first value of the address is recoverable by searching for a value, stored by a first memory bank, by consuming a predetermined number of bits of a data unit from a data packet. If present, a subsequent value of the address is recoverable by searching another memory bank of the pipeline for a value of the address contained by a node of a linked list. The pipeline recovers the address by combining value found at the first memory bank with the value found by the node of the linked list at the other memory bank.

### CROSS-REFERENCE TO RELATED APPLICATION

This application claims priority to and the benefit of both U.S. Provisional Patent Application No. 61/830,786 filed Jun. 4, 2013 and U.S. Provisional Patent Application No. 61/917,215 filed Dec. 17, 2013 the disclosures of which are incorporated by reference herein in their entirety.

### BACKGROUND

The present disclosure relates to a network device that processes packets.

The background description provided herein is for the purpose of generally presenting the context of the disclosure. Work of the presently named inventors, to the extent it is described in the background section, as well as aspects of the description that may not otherwise qualify as prior art at the time of filing, are neither expressly nor impliedly admitted as prior art against the present disclosure.

As part of their packet processing, network devices perform various search operations including exact match (EM) searching and longest prefix matching (LPM) on packet data. Conventionally, memory space for these searching and matching operations is comparatively poorly utilized. Moreover, the efficient management of the memory space for EM and LPM searching can be challenging. Conventional methodologies for classification typically require elaborate and expensive memory components and can be overly time consuming for some applications.

### SUMMARY

One or more example embodiments of the disclosure generally relate to storing and retrieving network forwarding information, such as forwarding of OSI Layer 2 MAC addresses and Layer 3 IP routing information. A pipeline of memory banks stores the network addresses as a pipelined data structure. The pipelined data structure is distributed as values of a data structure, separately searchable, at each of the memory banks.

A first memory bank of the pipeline stores values of the data structure, and each value stored at the first memory bank points to a next memory bank containing a next value of the data structure.

### BRIEF DESCRIPTION OF THE DRAWINGS

FIG. 1 shows a pipeline of memory banks according to example embodiments.

FIG. 2 shows a data value distributed among memory banks of a pipeline according to example embodiments.

FIG. 3 shows a pipeline of memory banks containing EM tables and buckets according to example embodiments.

FIG. 4 shows a flow diagram of an example method according to example embodiments.

FIG. 5 shows a pipeline of memory banks utilizing a combination of EM engine accessible and LPM engine accessible tables according to example embodiments.

FIG. 6 is a flow diagram of an example method according to example embodiments.

### DETAILED DESCRIPTION

In the following discussion, descriptions of well-known functions and constructions are omitted for increased clarity and conciseness.

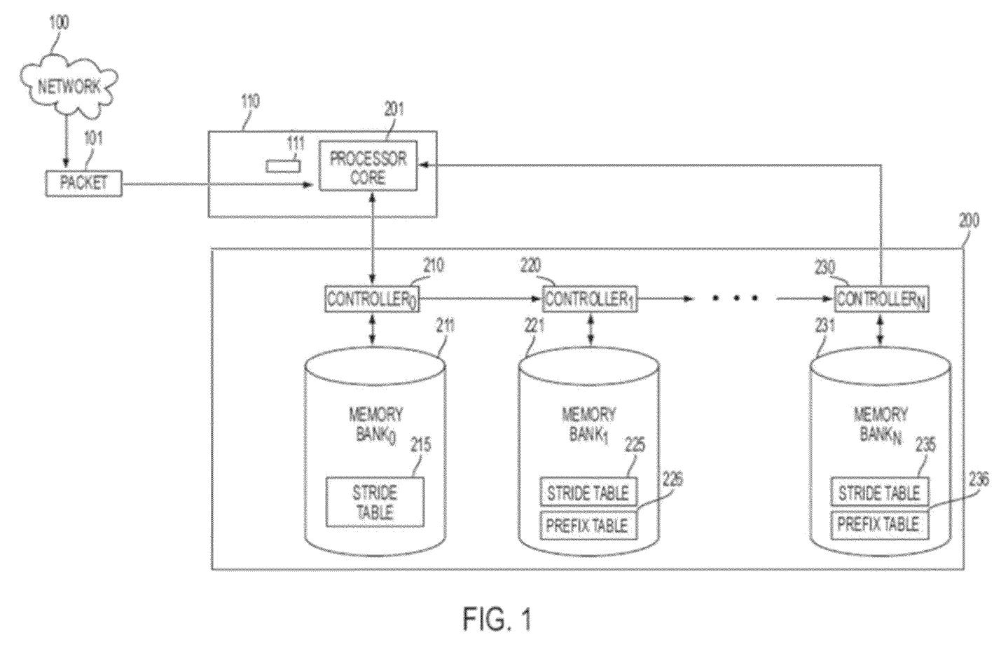

FIG. 1 shows a network 100, a network device 110, and a pipeline 200. The network device 110 is configured to buffer any received packet and to send the packets to the pipeline 200. The pipeline 200 includes a processor core 201, a memory bank 211, a memory bank 221, and a memory bank 231.

The network device 110 is configured to request the pipeline 200 to perform resource intensive lookup operations such as a plurality of searches for values of one or more packet forwarding addresses in response to receiving a packet, such as packet 101, from a network 100. Further the network device 110 is configured to receive a serial stream of packets (not shown) where at least a portion of one or more packets of the stream, after a processing operation at the network device 110, is used by the network device 110 to perform lookup operations on received serial stream of packets.

The pipeline 200 comprises a plurality of memory banks, memory bank 211, memory bank 221, memory bank 231, each of the memory banks being configured to perform at least one lookup operation per clock cycle, in an embodiment. Accordingly, a total number of lookup operations during a single clock cycle is directly proportional to the total number of memory banks, in an embodiment.

Further, each memory bank of the pipeline 200 is configured to perform a respective lookup operation for a respective packet of the serial stream of packets and to both pass an indication of the result to a next memory bank and to also receive a next packet of the serial stream of packets. Accordingly, a total number of packets, or portions of packets, for which the pipeline 200 is configured to search at a distinct clock cycle is directly proportional to the total number of memory banks, in an embodiment.

According to an example embodiment, the processor core 201 is configured to process data packets received from the network, to selectively send data to the controller 210 of pipeline 200 and to receive data from controller 230. The received data from controller 230 indicates a result of a plurality of lookup operations, each one of the lookup operations being performed at a respective one of the memory banks.

The network device 110 includes a packet processor (not shown) which is configured to send a data unit to the pipeline 200 for an inquiry regarding a network packet forwarding operation such as finding a next location for forwarding and/or routing. The pipeline 200 is a resource external to the packet processing engine of the network device 110 and is configured to perform resource intensive processing operations, such as an address lookup, as part of packet processing.

According to example embodiments, processing core 201 includes a pipeline of programmable processors, multiple processing engines that are arranged as an ASIC pipeline, or a multiplicity of non-pipelined run-to-completion processors.

The pipeline 200 is typically part of the network device and functions as a resource that is used by the packet processor for various address look operations. In accordance with an embodiment, although part of the network device, pipeline 200 is external to the packet processor.

The pipeline 200 allows for both storage and retrieval of a plurality of values of a network forwarding and/or routing address stored as a data structure which is distributed among memory banks of a pipeline. As used herein, the terms forwarding address and routing address are used interchangeably. The pipeline processor is configured to store, to search for, and to re-combine the distributed values found by searching each component of the data structure, in an embodiment.

According to an example embodiment, the pipeline 200 forms a data structure corresponding to a respective one of the forwarding addresses and each memory bank stores a portion of the data structure. As such, a first portion of the data structure is stored at a first memory bank and subsequent memory banks each respectively store subsequent portions of the data structure. Retrieving the data structure requires traversing ones of the memory banks containing the portions.

Both memory compactness and efficient retrieval are achieved by distributing the portions of the data structure among the memory banks through balancing stride tables and prefix list tables by where they are most effective. Stride tables are better where stored data has high entropy and prefix list tables where stored data has low entropy. The decreased searching complexity is directly related to splitting the forwarding address into a distributed data structure. Each portion of the data structure requires less space and less computational complexity for retrieval than would a non-split forwarding address or a non-pipelined data structure, because each portion of the data structure is stored at a respective partitioned area of a memory bank.

According to an example embodiment, each partitioned area of the memory bank is a physically separate memory bank having a separate input/output bus. According to an example embodiment, the respective partitioned areas are logical partitions of a same physical memory bank.

The partitioned area is addressable and decreases the computational complexity which would be expected when all available memory positions of a non-partitioned memory bank were available for storing the portion of the data structure. Furthermore, an operation of retrieving each portion of the data structure is simplified since each memory bank contains only a portion of the data structure thereby allowing for a first operation, regarding a first forwarding address, to search the memory bank 211 for the partial component of the data structure, and then move on to the next memory bank 221 while a second operation, regarding some other search, is allowed access to the first memory bank 211. Accordingly, the pipeline 200 allows for a plurality of partial searches, each for a different forwarding address, to be performed in parallel.

FIG. 1 shows the lookup pipeline 200 to include a controller 210, a controller 220, and a controller 230 communicatively coupled to the processor core 201 and also communicatively coupled to each of memory bank 211, memory bank 221, and memory bank 231 respectively. Furthermore, there are a plurality of memory banks and respective controllers (not seen) between memory bank 221 and memory bank 231, according to example embodiments.

The memory bank 211 includes at least one partitioned area, such as a stride table 215. A stride table includes at least one function to be combined with a portion of a data unit. When the function and data unit are combined, the portion of the data unit is consumed. Consumption of the data unit is subsequently used to determine a value stored by the stride table. In other words, the stride table 215 is configured to reveal a value of a data structure when its local function, a key function, is combined with a data unit, thereby completing the key.

According to an example embodiment, a stride table comprises 16 stride value entries. A stride table comprises a block address which points to a prefix list from the current stride table. The most significant bits, of a block address which points to a prefix list, are shared among all stride value entries pointing to a prefix list from the current stride table.

A stride table also comprises a block address which points to another stride table from the current stride table. The most significant bits, of a block address which points to another stride table, are shared among all stride value entries pointing to a stride table.

A stride table also comprises a 20-bit next hop pointer belonging to a previous stride value entry. According to an example embodiment, when the next hop pointer is 0xFFFFF then the next hop pointer is invalid and the next hop pointer from a previous stride is used.

According to an example embodiment, a local function of the stride table includes a number of bits of an incomplete value. The portion of the data unit, another number of bits, is combined with the local function to indicate a position within the stride table, the position containing a value of the data structure. Further, when another portion of the data unit or a portion of another data unit combines a number of its bits with those of the local function of the stride table, a different position within the stride table is indicated.

The memory bank 221 includes at least two logical partitions respectively including a stride table 225 and a prefix table 226.

The stride table 225 includes a second local function to be combined with a data unit to reveal a second value of a data structure. This data unit is a non-consumed part of the data unit used by stride table 215. This second value of the data structure refers to a second portion of a forwarding address subsequent to a first portion of a forwarding address. In an embodiment, the forwarding address is a layer 3 routing address, however in other embodiments the forwarding address is a layer 2 address.

The prefix table 226 contains a plurality of nodes of a plurality of linked lists. Each node contains both an element corresponding to one or more multiple respective forwarding addresses as a portion of a data structure, and a pointer to a node contained by a prefix table of another memory bank. One of the nodes, when searched, reveals a second portion of the data structure corresponding to a forwarding address portion subsequent to the first portion of the forwarding address, where the first portion of the forwarding address is found at stride table 215.

The memory bank 231 includes two partitioned areas each respectively including a stride table 235 and a prefix table 236.

The stride table 235 includes a third local function to be combined with a data unit to reveal a third value of a data structure. This third value of the data structure referring to a third portion of a forwarding address subsequent to the second portion of the forwarding address, where the second portion of the forwarding address is found at stride table 225.

The prefix table 236 contains a plurality of nodes of a plurality of linked lists. One of the nodes, when searched, reveals a third portion of the data structure corresponding to a forwarding address portion subsequent to a second portion of the forwarding address, where the second portion of the forwarding address is found at the stride table 225.

According to an example embodiment, a portion of a data unit 111, such as a portion of a packet 101 received by a network device 110 from a network 100, is used to activate a function of stride table 215. A portion of the data unit 111 combines with a function, such as a key, stored by the stride table 215 to determine a value of the data structure corresponding to a forwarding address. Hereinafter, combining a portion of the data unit 111 with a function of a memory bank is referred to as “the portion.” Each entry in a prefix list contains all remaining portions of the forwarding address, after initial portions have been consumed by stride tables.

According to an example embodiment, either a next portion of the data unit 111 is consumed by memory bank stride table 225, or a node of a linked list stored by a prefix table 226 is searched. Hereinafter, it is noted that a first portion of the data structure corresponding to a forwarding address is stored as a first type of data, such as that stored by a stride table or an exact match table, and a second portion of the same data structure is stored by a prefix table.

Therefore, an operational complexity of retrieving a network address from a pipelined data structure, as herein described, is decreased by utilizing and mixing attributes of searching stride tables, exact match tables, and prefix tables. The operational complexity refers to finding some value within a predetermined number of operations. Accordingly, as the data structure is distributed among respective partitions of a plurality of memory banks, each partition becomes more compact and easier to maintain thereby decreasing the operational complexity, as described above.

According to an example embodiment, the pipeline 200 is configured to store a remainder of a data structure as nodes of a linked list distributed among prefix tables when a stride table utilization level reaches a predetermined and configurable threshold.

According to an example embodiment, a value stored by a stride table is determined to direct the pipeline 200 to search another stride table or a prefix table, and a value stored by a prefix table is determined and then used to direct the pipeline 200 to search any other prefix table found at any subsequent one of the memory banks of the pipeline 200.

Hereinafter, the terms “previous” and “subsequent” will be used as follows: Memory bank 221 and memory bank 211 are “previous” to memory bank 231. Memory bank 211 is “previous” to memory bank 221, and memory bank 231 is “subsequent” to memory bank 221. Memory bank 221 and memory bank 231 are “subsequent” to memory bank 211.

Each of the controllers, controller 210, controller 220, and controller 230, is configured to control read and write access, by hardware, software, or a combination to a respective one of the memory bank 211, memory bank 221, and memory bank 231. The memory banks are further configured to interchange their stored data to balance storage compaction with the complexity of the searching mechanisms. According to an example embodiment, more or fewer than the illustrated number of controllers are configured to determine when a searched and reading operation is requested to be performed at a respective memory bank of the pipeline 200 to determine the address to read.

Each of the stride tables, stride table 215, stride table 225, and stride table 235, is configured such that a portion of an address, searchable by a longest prefix match mechanism, is stored in a distributed or pipelined manner.

In an example embodiment, “pipelined” refers to locations which are physically separated and, in this case, memory banks which are capable of storing respective parts of a forwarding address as a data structure. Subsequent retrieval of such pipelined data requires traversal of each memory bank containing the values which, when each of the values is retrieved, the reassembled value corresponds to a forwarding address. Further, each memory bank includes a mechanism indicating where to search for a value in a next memory bank.

A value of a stride table, a table containing values each corresponding to a portion of a respective forwarding address, is searchable by consuming a predetermined number of bits of a data unit, such as a packet or portion of a packet received from a network. Accordingly, the values stored by the memory banks of the pipeline 200 have a predetermined correspondence to at least a part of a respectively received data unit.

A value of a prefix table comprises a node of a linked list containing both an element corresponding to a portion of a respective forwarding address and a pointer to a node contained by a prefix table of another memory bank.

According to example embodiments a network device 110 receives a packet 101, of a series of packets (not shown), from a network 100 and subsequently performs various packet processing operations on the packet at a packet processor (not shown) associated with the network device. During processing, some of the operations, such as address lookups, are provided by dedicated engines associated with the network device external to the packet processor. The external operations use a data unit resulting from the packet processing operation, such as an extracted data unit of an Open Systems Interconnection (OSI) Layer 2 MAC addressing or OSI Layer 3 IP routing protocol, to the pipeline 200. The data unit 111 a portion corresponding to the packet 101 or a value translated from a portion of the packet 101, such as the above described OSI layer information. The data unit 111 is used to determine that a memory bank 211 is to be searched for a first portion of the data structure. According to an example embodiment, when the controller 210 searches the stride table 215 of memory bank 211, the value used in addressing the stride table stride table 215 of the memory bank 211 is not used with a local hash function in for directly determining a value of the data structure. Subsequently, the controller 220 determines that stride table 225 of memory bank 221 contains a next value by consuming another one of the portions of the data unit 111. According to an example embodiment, both the value addressing the memory bank 211.

The controller 210 extracts information corresponding to a portion of the data structure from the stride table 215 of the memory bank 211 by allowing portion of the data unit 111 to be consumed by a local function of the stride table 215.

Upon consuming the portion of the data unit 111 and extracting the value from the stride table 215, the controller 210 determines that a next portion of the desired forwarding address is found at memory bank 221 by determining either that a next portion of the data unit 111 is to be consumed by the stride table 215 or that a next portion of the data structure is searchable at prefix table 226.

According to an example embodiment, the network device 110 is configured to receive a serial stream of packets (not shown), each over a finite time period, and to transmit at least a respective data unit 111 to the pipeline 200.

The processing core 201 extracts a serial stream of data units, in an embodiment, each data unit causing the packet processor of the network device 110 to initiate a search for a respective forwarding address stored as a respective distributed data structure among the memory banks 211-231 of pipeline 200. Each data unit is used by a respective one of the controllers at each subsequent memory bank at a next clock cycle allowing for respectively parallel processing of the serial stream of packets such that a first lookup occurs during the same clock cycle as a second lookup, each lookup being for a respective one of the packets of the serial stream of packets. Hereinafter, it is noted that operations involve parallel processing, and a number of reading and writing operations available per clock cycle is directly related to the number of memory banks when at full operational capacity, that is, when each respective controller is searching one of the memory banks. Further, parallel processing refers to performing, during the same clock cycle, a plurality of lookups, each of the plurality of lookups occurring at a respective one of the memory banks and each of the plurality of lookups corresponding to a lookup to find a value of a respective data structure.

According to the determination by the controller 210 with respect to the data unit 111 and a result of searching the memory bank 211, an indication is sent to the controller 220 to continue the searching operations through the stride table 225 or the prefix table 226.

Likewise, the controller 220 determines when a value of the stride table 225 indicates a requirement to search the stride table 235 or the prefix table 236 of the subsequent memory bank 231.

Further, the controller 230 receives an indication from a previous controller regarding a required search of the stride table 235 or the prefix table 236.

According to example embodiments, when a last value of a linked list, such as a last value of the data structure or a null node of a linked list, is found at one of the respective prefix tables, the overall next forwarding address is carried out by the following paths including traveling along the remainder of the pipeline until network access is available or immediately exiting the pipeline for network forwarding or further processing, such as dropping the packet 101 or applying a quality of service to the packet 101 or stream of serial packets.

Controller 210 stores values as stride table components. Controller 220 and controller 230 store values as stride table components and as nodes of a linked list based on a predetermined weighting function which is reconfigurable based on a current storage usage of the memory banks.

It is noted that, in an embodiment, pipeline 200 takes advantage of a processing time interval for processing received packets 101 to perform an address lookup operation. Thus, as an engine that is external to the processing core 201, the lookup pipeline 200 is configured to utilize a portion of the time interval to perform a pipelined address lookup operation in parallel to other processing operations that performed on the received packet at processing core 201.

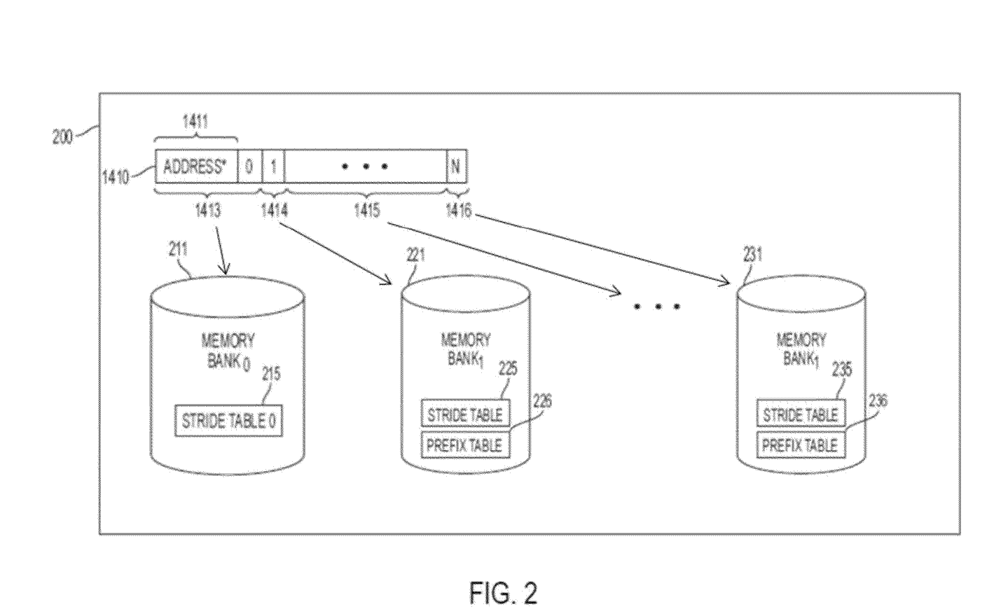

FIG. 2 illustrates the manner in which respective portions of a data unit 1410, such as an address for at least the OSI routing operation protocols described above, are stored as a corresponding data structure, in various memory banks, and subsequently searched.

FIG. 2 shows a pipeline 200, memory bank 211, memory bank 221, and memory bank 231 in accordance with an embodiment. Each of the memory banks, memory bank 211, memory bank 221, and memory bank 231, includes a respective stride table, such as stride table 215, stride table 225, and stride table 236. Memory bank 221 and memory bank 231 each include respective prefix tables, prefix table 226 and prefix table 236.

According to an example embodiment, the pipeline 200 is configured to use a number of bits of a data unit 1410, such as a header 1411 and corresponding to the stored data structure, to begin a searching operation. In the embodiment, the data unit 1410 is received from a network (not shown) as part of a network routing operation. The header 1411 is determined to address the stride table 215 of memory bank 211. According to an example embodiment, the number of bits of the data unit used to begin the searching operation corresponds to the least significant bits of the data unit 1410.

A value of the data structure corresponding to the address portion 1413 is searchable at stride table 215 of memory bank 211. A value of the data structure corresponding to a second address portion 1414 is searchable as a value at stride table 225 and as a node of a linked list at prefix table 226. Values of the data structure corresponding to intermediate portions 1415 of the data unit 1410 are searchable at any number of immediately subsequent, intermediate memory banks of the pipeline 200 as values at stride table 225 and as a node of a linked list at prefix table 226. A value of the data structure corresponding to a final value 1416 of address 1400 is searchable as a final node of a linked list at prefix table 236.

According to an example embodiment, the value 1414, values 1415, and value 1416 are stored in prefix list table value entries in a single memory bank, such as at memory bank 221. According to another example embodiment, value 1414 is stored as stride table data in memory bank 221 and values 1415 and value 1416 are stored by prefix list table value entries in a single memory bank, such as a memory bank subsequent to memory bank 221.

Further, accessing the pipeline 200 includes first using a predetermined number of bits of a data packet, such as bits corresponding to a header 1411, as an address which directs the pipeline to search the stride table 215 of memory bank 211, as indicated by the address, for a value corresponding to the respective portion of the data structure. The pipeline 200 is further configured such that a value of stride table 215 directs the pipeline to perform a search for another value at stride table 225 and a search for a node of a linked list at prefix table 226.

This process continues throughout the pipeline 200 until the address is recovered by re-assembling the distributed data structure.

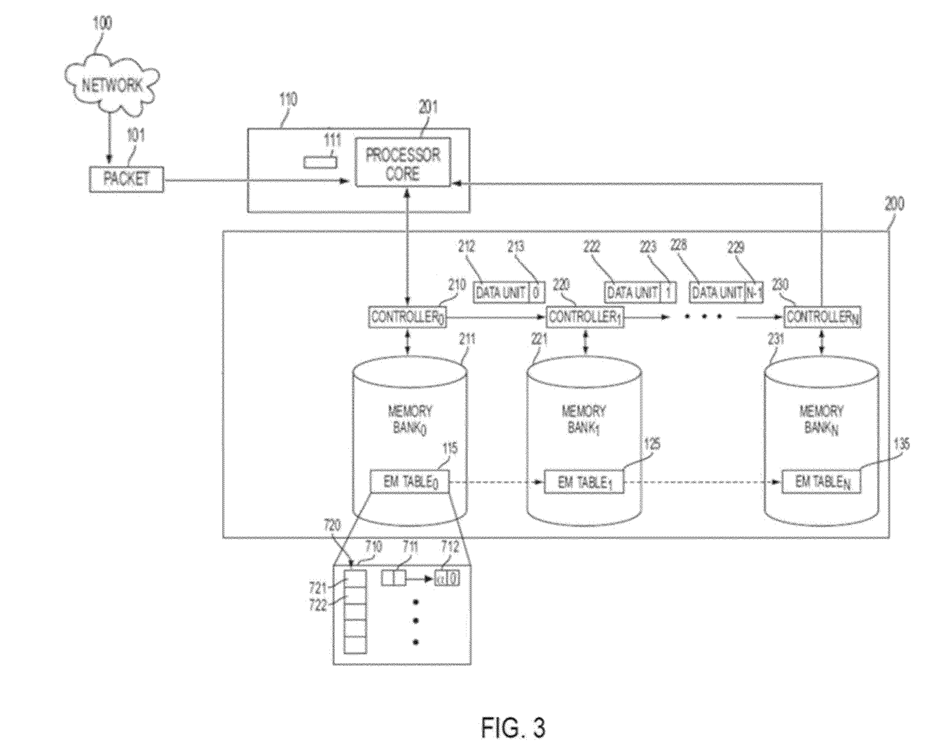

FIG. 3 shows a network 100 a network device 110, and a pipeline 200. The pipeline 200 comprises processing core 201, controller 210, controller 220, controller 230, memory bank 211, memory bank 221, and memory bank 231.

Memory bank 211, memory bank 221, and memory bank 231 each respectively include partitioned areas such as exact match (EM) table 115, EM table 125, and EM table 135.

Each address 710 of an EM table can store two full keys, for example address 721 stores first key 711 and second key 712. These keys are combinable with portions of the data unit 111 according to embodiments described above. A predetermined number of bits of a data unit 111 and first key 711 correspond to each other, a value, such as a portion of a network forwarding address, is output. If the bits of the data unit 111 and the first key 711 do not correspond, the same portion of the data unit 111 is extracted and combined with the second key 712, and when the bits of the data unit data unit 111 correspond to key 712, a value, such as a portion of a network forwarding address, is output. The bits of the data unit 111, as referred to in this paragraph, correspond to the least significant bits of the data unit 111; however, this is merely an example embodiment, and other portions of the data unit 111 are likewise utilized.

Accordingly, each respective controller utilizing an EM table is capable of recovering a number of values of the data structure equal to the number of keys stored by an address. Although not shown, any address of the addresses 720 of EM table 115 contains any suitable number of keys. According to an example embodiment, address 722 contains the same number of keys as address 721. Further, each of the addresses of any EM table is addressable by at least a portion of the data unit 111.

FIG. 3 further shows that the network device 110 receives a packet 101 from the network 100. The processing core initiates a search of the pipeline 200 by sending a data unit 111 to the lookup pipeline 200. The data unit 111 corresponds to at least a portion of the packet 101 from which a portions of a data structure is to be searched for by comparing the search data, a portion of the data unit 111, with the respective key 711 and key 712.

Each of controller 210, controller 220, and controller 230 is configured to search respective memory banks according to the data unit 111 and an indication of the search results from a previous memory bank.

According to an example embodiment, the pipeline 200 uses the data unit 111 to determine a correspondence with a local function of the EM table 115 for searching the EM table 115 of memory bank 211. Subsequent banks of the pipeline allow the result to exit the pipeline 200 when a match is found at memory bank 211. Controller 210 outputs data unit 212 and indication 213 corresponding to a result of the search of memory bank 211.

Controller 220 is configured to receive the data unit 212 and indication 213, and to perform a search of the stride table 225 of memory bank 221. Controller 220 is further configured to output a data unit 222 and an indication of the search and result found by controller 220.

Controller 230 is configured to receive a data unit 228 and an indication 229 of the search found at a previous memory bank. The data unit 228 and indication 229 are received by the controller 230 from a controller (not shown) disposed between controller 220 and controller 230. The controller 230 performs a search of EM table 135 of memory bank 231. According to example embodiments, a positive match in any of memory bank 211 and memory bank 221 is carried to subsequent memory banks through indication 213 and indication 223, respectively, together with either a network address, such as a forwarding address or a data structure corresponding to a network address by which the packet 101, the data unit 111, or the data unit 228 is to be forwarded.

FIG. 3 also illustrates an architecture for populating the memory banks of the pipeline 200.

According to an example embodiment, the pipeline 200 is configured to receive a data unit of a received packet. The controller 210 is configured to generate a first value, such as a hash key, to correspond to an expected data unit, to be received from the network 100, and to search the memory bank 211 to determine whether the newly determined value corresponds to or collides with any previously stored value.

When the newly determined value collides with a previously stored value, the controller 210 redirects the stored value to another position of another memory device of the pipeline.

The controller 210 is further configured to output an indication of a result of the search, such as an indication to a subsequent memory device of a collision and subsequent redirection.

The controller 220, which provides a transfer logic, operates between the controller 210 and the memory bank 221, in an embodiment. The controller 220 generates a different respective hash value corresponding to the data unit 111 for the memory bank memory bank 221, and the controller 220 also searches the memory bank 221 to determine whether the respective different hash value corresponds to any stored hash value in the respective memory bank 221 (i.e. it performs a search for a collision). The controller 220 subsequently outputs an indication of a result of the collision search at the controller 230.

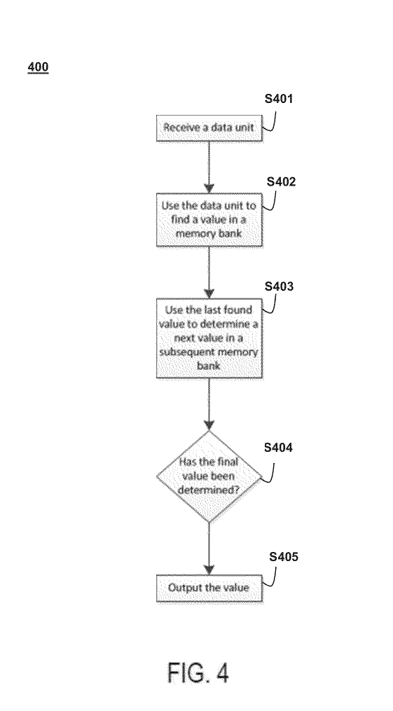

FIG. 4 is a flow diagram 400 of an example algorithm and method, according to example embodiments, when a data unit is received by the pipeline device. The example method of FIG. 4 applies to multiple example embodiments in which the pipeline device is utilized, for example the pipeline 200 of FIG. 3. Processing begins at S400 at which the pipeline 200 receives a data unit from a packet of a network session. Processing continues at S401.

At S402, a controller of the pipeline uses the data unit to find a value in a memory bank by combining a portion of the data unit with a key stored implicitly, as a local function, as part of and address in the to-be-searched table. The first memory bank of the pipeline to be searched is indicated by at least a predetermined and configurable portion of a data unit with a key or plurality of keys of the addressed table. Processing continues at S403.

At S403, a controller of the pipeline uses a last found value, such as a value of the found data structure or a next portion of the data unit, to determine a location, an address of a table, to search in a subsequent one of the memory banks of the pipeline. According to an example embodiment, S403 is performed by the pipeline during a longest prefix match operation. Processing continues at S404.

At S404, a controller of the pipeline determines whether an address has been determined based on a currently found value. When an address has not been determined, then the processing continues at S403. When an address has been determined, then the processing continues at S405.

At S405, the pipeline outputs the address.

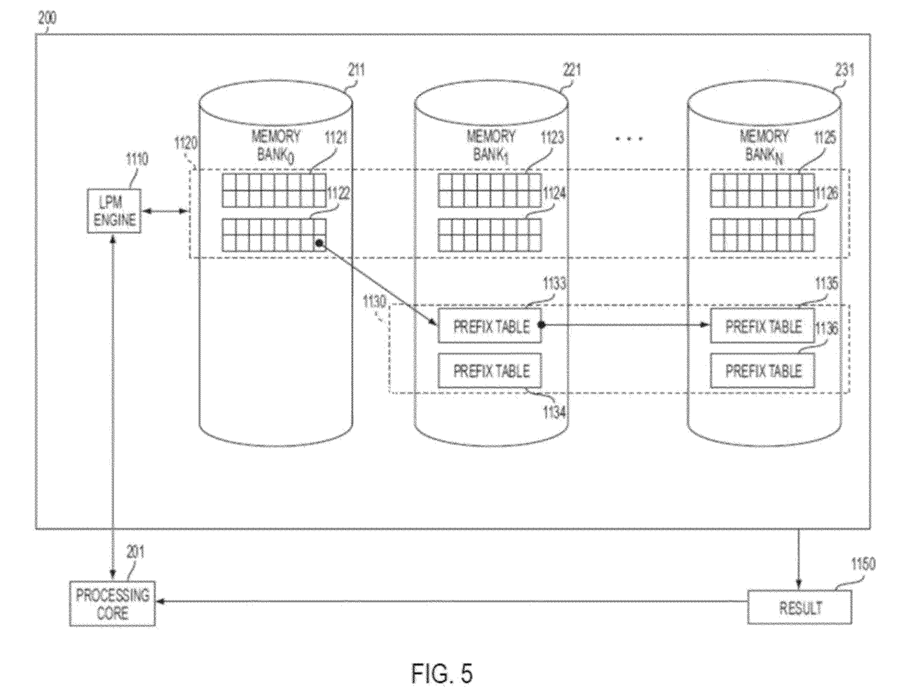

FIG. 5 shows a pipeline 200 including a processor core 201, an LPM engine 1110, a memory bank 211, a memory bank 221, and a memory bank 231.

The LPM engine 1110 is configured to control access to the specific pipeline storing data structures corresponding to a received data unit. According to an example embodiment, the data structure, accessed by the LPM engine 1110 through the memory banks of the pipeline, corresponds to a network address and is stored by the pipeline as a combination of stride table value entries 1120 and prefix table value entries 1130.

Memory bank 211 includes an area, which according to an example embodiment is partitioned, including stride table 1121 and stride table 1122 each configured to store values of a plurality of data structures. Each of the stored values respectively corresponds to both a portion of an address and an additional indication, such as an indication of a location to search for a next value of the address at a table of another memory bank.

Memory bank 221 includes an area, which according to an example embodiment is partitioned, including stride table 1123 and stride table 1124, each configured to store values of a plurality of data structures, with each value corresponding to a portion of an address and an indication to search for a next value of the distributed address at a stride table of another memory bank or an indication to search for a next value of the distributed address at a node of a linked list stored by a prefix table of another memory bank. Memory bank 221 also includes a separate area, which according to an example embodiment is partitioned, including prefix table 1133 and prefix table 1134, each configured to store a plurality of nodes of a plurality of linked lists, each node pointing to a node contained by a prefix table of a different memory bank.

Memory bank 231 includes a partitioned area including stride table 1125 and stride table 1126, each table being configured to store a plurality of last value entries each entry indicating a last value of a distributed address. Memory bank 231 also includes an area, which according to an example embodiment is partitioned, including prefix table 1135 and prefix table 1136, each table being configured to store a plurality of last nodes of a plurality of linked lists of data structures.

According to an example embodiment, the LPM engine 1110 controls the pipeline 200 to search for a value stored by the pipeline of stride table value entries 1210, and if indicated, the prefix table value entries 1130. The LPM engine 1110 also determines whether the searched value directs the LPM 1140 to search a next memory bank for another value of the data structure corresponding to a portion of the address.

According to an example embodiment, the illustrated data structure, ends at memory bank 231 with a final value of the address stored as a node at prefix table 1135. The pipeline 200 assembles a complete address by combining the values found throughout the memory banks and outputs the result 1150.

According to an example embodiment, the processing core completes processing of a packet, using the address result 1150 returned from the pipeline 200, and subsequently forwards the packet according to the result 1150 to a next location such as another network address. According to an example embodiment, the result 1150 is a next hop pointer which is 20 bits wide.

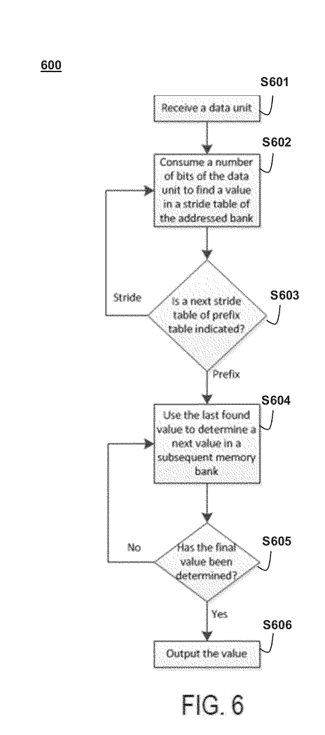

FIG. 6 is a flow diagram 600 of an example algorithm and method, according to example embodiments, performed when data is received by the pipeline device. The example method of FIG. 6 applies to multiple example embodiments in which the pipeline device is utilized. Processing begins at S601 as the pipeline receives a data unit from a packet of a network session. Processing continues at S602.

At S602 a controller of the pipeline uses the data unit to find a value, in a memory bank, by consuming a predetermined number of bits of the data unit. According to an example embodiment, in a 4-bit mode, four bits of the data unit are used to select an entry of a table, and in a 5-bit mode, the most significant bit of the portion of the data unit is used to select the table while the remaining four bits select the entry.

The portion of the data unit corresponds to a memory bank and a position within a stride table of the indicated memory bank to be searched. Processing continues at S603.

At S603 the controller of the pipeline determines if the value found at S602 indicates a next stride table or a next prefix table is to be searched for a next value of an address. If a next stride table is indicated, the processing continues at S603 by searching a portion of the next stride table at a position indicated by consuming a number of bits of the data unit. If a next prefix table is indicated, the processing continues at S604.

At S604, the controller of the pipeline has determined that a next value of the address is to be found at a node of a linked list stored in a subsequent memory bank. The controller searches the node of the linked list at the subsequent memory bank and determines both a value of the address and a pointer to another node of the linked list at a next memory bank. Processing continues at S605.

At S605, the controller determines if the final value of the address has been determined. According to an example embodiment, the final value of the address is determined to be found when a last node of the linked list is found. If the controller determines that the final value has not been found, processing continues at S604. If the controller determines that the final value has been found, processing continues at S606.

At S606, the controller outputs the result of the value, which is a next address for forwarding a packet corresponding to the original data unit used at S601.

Although the inventive concept has been described above with respect to the various example embodiments, it is noted that there can be a variety of permutations and modifications of the described features by those who are familiar with this field, without departing from the technical ideas and scope of the features, which shall be defined by the appended claims.

Further, while this specification contains many features, the features should not all be construed as limitations on the scope of the disclosure or the appended claims. Certain features described in the context of separate embodiments can also be implemented in combination. Conversely, various features described in the context of a single embodiment can also be implemented in multiple embodiments separately or in any suitable sub-combination.

Although the drawings describe operations in a specific order and/or show specific arrangements of components, one should not interpret that such specific order and/or arrangements are limited, or that all the operations performed and the components disclosed are needed to obtain a desired result. Accordingly, other implementations are within the scope of the following claims.

What is claimed is:

1. A network device including a search engine, the search engine, comprising:
a pipeline of multiple memory banks including a first memory bank and at least one subsequent memory bank,
the first memory bank partitioned to store values of a data structure corresponding to a portion of a network address, and
the at least one subsequent memory banks partitioned to store any of other values corresponding to the portion of the network address and a node of a linked list, the node of the linked list comprising an element corresponding to the portion of the network address and a pointer to another node of the linked list of a third subsequent memory bank;
one or more memory controllers configured to perform a first search, of a series of searches, of the values stored by the first memory bank and, responsively to the first search, to perform a second search, of the series of searches, by searching either the other values stored in the at least one subsequent memory bank or the node of the linked list.

2. The search engine of claim 1, wherein the one or more memory controllers are further configured to consume a first portion of a data unit during a first search and to consume, when the memory controller is to perform the second search of the other values stored in the subsequent memory bank, a second portion of the data unit during the second search based on results of the first search.

3. The search engine of claim 1, wherein the one or more memory controllers are further configured to perform a subsequent search, of another series of searches, of the values stored by the first memory bank during the same clock cycle as the second search.

4. The search engine of claim 3, wherein the one or more memory controllers are further configured to perform, during the same clock cycle, the second search of the other values and a traversal of the linked list in response to a result of the subsequent search.

5. The search engine of claim 1, wherein a most subsequent one of the one or more memory controllers is further configured to combine the result of the first search and a result of the second search into the network address.

6. A match engine device method, comprising:
performing a series of partial searches, in a search pipeline, on a packet of a stream of packets, each of the series of partial searches occurring in at least one of multiple memory banks arranged in a search pipeline; and
completing a search when a last resource, subsequent to all other resources, of the search pipeline is searched and a next address has been determined by which to forward the packet.

7. The match engine device method of claim 6, further comprising:
receiving a data unit of the packet at a first memory bank,
extracting a first portion of the data unit;
performing a first partial search, of the series of partial searches, at the first memory bank by using the first portion of the data unit;
outputting an indication, of the first partial search of the first memory bank, and the data unit to a subsequent one of the memory banks;
performing a second partial search at the subsequent one of the memory banks;
determining that the first partial search points to a linked list distributed among subsequent ones of the multiple resources; and
completing a search by traversing the linked list.

8. The match engine device method of claim 7, further comprising performing another first partial search, of another series of partial searches, for another packet of the series of packets at the first resource during a same clock cycle as the second partial search.

9. The match engine device method of claim 7, wherein the extracting the first portion of the data unit comprises extracting a predetermined number of bits of the data unit.

10. The memory engine device method of claim 6, further comprising:
receiving a plurality of subsequent packets supplied to the search pipeline, each subsequent packet being respectively supplied at a next clock cycle, and, writing to at least one of the multiple resources in response to at least one of the subsequent packets.

11. The memory engine device method of claim 6, further comprising receiving, by at least one of the resources, a request to re-configure a plurality of memory positions of a plurality of stored values; and re-configuring the plurality of memory positions.

12. A match engine device, comprising:
a memory space including a communicatively coupled series of separate memory devices, each memory device of the separate memory devices storing a multiplicity of values;
a memory space front end configured to receive a data unit corresponding to a packet received from a network, to generate a first value corresponding to the data unit, to search the first memory device to determine whether the first value corresponds to a value stored in a first separate memory device of the series of separate memory devices, and to output an indication of a result of the search;
a transfer logic configured to generate a respective different value corresponding to the data unit for respective ones of the subsequent separate memory devices based on results of searching at one or more previous memory devices, to search the subsequent separate memory device to determine whether the respective different value corresponds to a stored value in the respective subsequent separate memory device, and to output an indication of a result of the search.

13. The match engine device of claim 12, wherein when the transfer logic is further configured to determine whether a position indicated by the first value matches a position of the stored value of the first separate memory device, the stored value is redirected to another position within the first separate memory device.

14. The match engine device of claim 12, in response to determining that a position indicated by the respective different value matches a position of the stored value of the respective subsequent physically separate memory device, the stored value is redirected to another position to be stored in at least one of the plurality of separate memory devices.

15. The match engine device of claim 12, wherein a one of the plurality of separate memory device comprises a node of a linked list representing both a value of a forwarding address and a pointer to another node of the linked list stored by another one of the plurality of separate memory devices.

16. The match engine device of claim 12, wherein each of the plurality of separate memory devices is physically separated from each of the other memory devices.
